(19) United States
(12) Patent Application Publication
(10) Pub. No.: US 2010/0111438 A1
(43) Pub. Date: May 6, 2010

(54) ANISOTROPIC DIFFUSION METHOD AND APPARATUS BASED ON DIRECTION OF EDGE

(75) Inventors: June Young Chang, Daejeon (KR); Han Jin Cho, Daejeon (KR); Young Hwan Bae, Daejeon (KR); Won Jong Kim, Daejeon (KR); Mi Young Lee, Daejeon (KR); Ju Yeob Kim, Daejeon (KR); Guee Sang Lee, Gwangju (KR); In San Jeon, Daejeon (KR)

Correspondence Address: AMPACC Law Group, 3500 188th Street S.W., Suite 103, Lynnwood, WA, 98037, US

(73) Assignees: Electronics and Telecommunications Research Institute, Daejeon (KR); Industry Foundation of Chonnam National University, Gwangju (KR)

(21) Appl. No.: 12/612,055

(22) Filed: Nov. 4, 2009

(30) Foreign Application Priority Data
Nov. 4, 2008 (KR) 10-2008-0109081

(51) Int. Cl. G06K 9/40

(52) U.S. Cl. 382/266; 382/275

(57) ABSTRACT

An anisotropic diffusion method and apparatus based on the direction of an edge are disclosed. In the anisotropic diffusion apparatus, directional pattern masking is performed to determine the direction of an edge in an image including noise, and values obtained through the directional pattern masking are convoluted to calculate the magnitude of an image. If the calculated magnitude value of the edge is larger than a threshold value, the edge of the image is preserved, while if the calculated magnitude value of the edge is not larger than the threshold value, noise cancellation is strengthened, whereby noise can be effectively canceled (or concealed) while preserving the edge representing the characteristics of the image, and thus, an image of high quality can be obtained.

### CROSS-REFERENCE TO RELATED APPLICATIONS

This application claims the priority of Korean Patent Application No. 10-2008-0109081 filed on Nov. 4, 2008, in the Korean Intellectual Property Office, the disclosure of which is incorporated herein by reference.

### BACKGROUND OF THE INVENTION

1. Field of the Invention

The present invention relates to anisotropic diffusion and, more particularly, to an anisotropic diffusion method and apparatus based on the direction of an edge capable of maintaining an edge representing the characteristics of an image while canceling noise, to thus provide a high quality image from a noise-contained image.

2. Description of the Related Art

In general, in the case of an ultrasonic image, a synthesized aperture radar image, and the like, including speckle noise, image noise is concealed by using an anisotropic diffusion method.

As shown in FIG. 1, the anisotropic diffusion process is uniformly performed by calculating a tilt value with neighboring pixels with a cross-shaped kernel in four directions of east, west, south, and north.

The anisotropic diffusion in the cross-shaped kernel structure for noise concealment is processed according to a temporal and spatial discretization equation as represented by Equation 1 shown below, of which a diffusion rate is adjusted to be within the range of 0≦λ≦¼.

I_{i,j}^{t+1}=I_{i,j}^{t}+λ[c_{N}·∇_{N}I+c_{S}·∇_{S}I+c_{E}·∇_{E}I+c_{W}·∇_{W}I]_{i,j}^{t}

∇_{N}I_{i,j}≡I_{i-1,j}−I_{i,j}, ∇_{S}I_{i,j}≡I_{i+1,j}−I_{i,j},

∇_{E}I_{i,j}≡I_{i,j+1}−I_{i,j}, ∇_{W}I_{i,j}≡I_{i,j-1}−I_{i,j}

C_{D}=g(|∇_{D}I|), where D={East, West, South, North} [Equation 1]

In Equation 1, using an inverse proportion function of Perona and Malik of Equation 2 shown below and an exponent function of Perona and Malik of Equation 3, if the tilt value (∇I) is large, a corresponding pixel is regarded as an edge region, so C_{D} is controlled to stop diffusion. In Equation 2, the value ‘K’ is a threshold value for discriminating a homogeneous region and an edge region, to which a value gradually diminishing at each repetition stage of diffusion is allocated.

$$\begin{matrix}g ( \vert ∇ I \vert ) = \frac{1}{1 + {( \frac{( ‖ ∇ I ‖ )}{K} )}^{2}} & [ Equation 2 ] \\ g ( \vert ∇ I \vert ) = {{e}^{- ( \frac{\vert ∇ I \vert}{K} )}}^{2} & [ Equation 3 ]\end{matrix}$$

FIGS. 2a and 2b comparatively demonstrate the characteristics of the edge stopping functions in Equations 2 and 3.

The method of using the inverse proportion function of Equation 2 has the characteristics that it is effective for the diffusion of the homogeneous region, but it is difficult to maintain the edge region with a tilt value which is small and gentle, as shown in FIG. 2a. Meanwhile, the method of using the exponent function of Equation 3 has the characteristics that the diffusion of the homogeneous region is not easy, but the edge region with the small and gentle tilt value can be maintained.

If the tilt of the current pixel is |∇I|→0, the edge stopping function serves to increase the rate of diffusion to 1, while if the tilt of the current pixel is |∇I|→∞, the edge stopping function serves to diffuse the rate of diffusion to 0, reducing or stopping the rate of diffusion.

In this respect, however, if the diffusion is made t→∞, the anisotropic diffusion based on the cross-shaped kernel is made such that the edge is concentrated to be blurred in horizontal and vertical directions, causing a problem in that the characteristics of images cannot be preserved.

### SUMMARY OF THE INVENTION

An aspect of the present invention provides an anisotropic diffusion method and apparatus based on the direction of a noise edge capable of concealing noise while preserving an edge by using an edge stopping function to thus prevent the edge representing the characteristics of an image from being blurred in canceling (concealing) noise.

Another aspect of the present invention provides an anisotropic diffusion method and apparatus based on the direction of an edge capable of detecting an edge and determining the direction of the edge by employing four types of directional pattern mask calculations (i.e., arithmetic operations) and applying an edge stopping function according to the determined direction of the edge, thus canceling noise while preserving the edge.

According to an aspect of the present invention, there is provided an anisotropic diffusion method based on the direction of an edge by an anisotropic diffusion apparatus, including: performing direction pattern masking to determine the direction of an edge in an image including noise; calculating the magnitude of an edge by convoluting values obtained through the direction pattern masking; and canceling noise from the image while preserving the edge of the image according to the calculated magnitude value of the edge.

According to another aspect of the present invention, there is provided an anisotropic diffusion apparatus based on the direction of an edge, including: a masking unit configured to perform direction pattern masking to determine the direction of an edge in an image including noise; a magnitude calculation unit configured to calculate the magnitude of the edge by convoluting values obtained through the direction pattern masking; a comparison unit configured to compare the calculated magnitude value of the edge and a pre-set threshold value; an edge preserving unit configured to determine that a current pixel of the image corresponds to an edge if the magnitude value is larger than the threshold value, and preserving, the determined edge; and a noise canceling unit configured to determine that a current pixel of the image corresponds to a region, not to an edge, if the magnitude value is not larger than the threshold value, and strengthening noise cancellation of the image.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 illustrates an anisotropic diffusion in a cross-shaped kernel structure;

FIGS. 2a and 2b are graphs comparatively showing the characteristics of edge stopping function;

FIGS. 3a to 3d illustrate four types of directional pattern masks to detect an edge according to an exemplary embodiment of the present invention;

FIG. 4 is a schematic block diagram of an anisotropic diffusion apparatus for canceling noise while preserving an edge according to an exemplary embodiment of the present invention;

FIG. 5 is a flow chart illustrating the process of a direction-based anisotropic diffusion method according to an exemplary embodiment of the present invention;

FIGS. 6a to 6d illustrate edge directions determined after direction pattern masks are processed according to an exemplary embodiment of the present invention; and

FIG. 7 illustrates anisotropic diffusion in a region, not at an edge, according to an exemplary embodiment of the present invention.

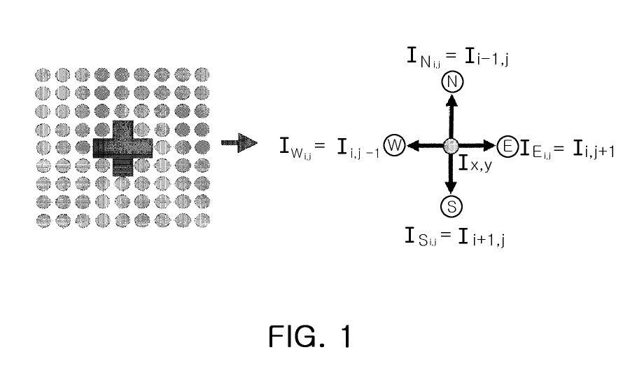

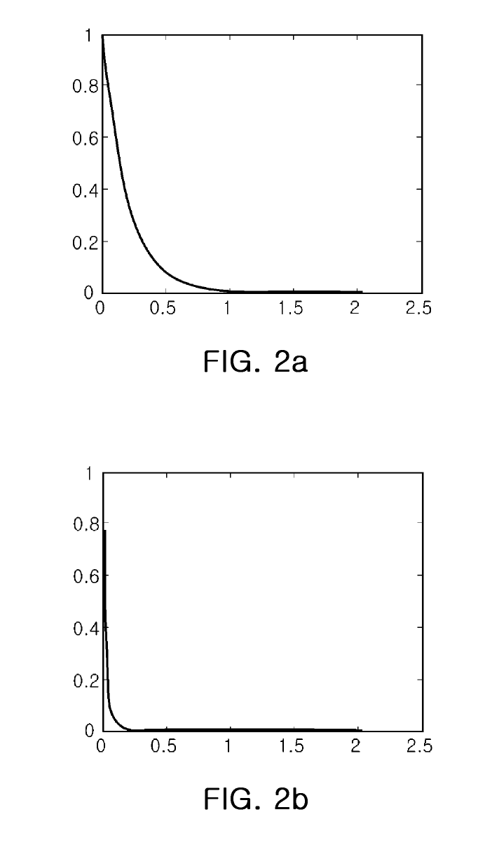

### DETAILED DESCRIPTION OF THE PREFERRED EMBODIMENT

Exemplary embodiments of the present invention will now be described in detail with reference to the accompanying drawings. The invention may however be embodied in many different forms and should not be construed as limited to the embodiments set forth herein. Rather, these embodiments are provided so that this disclosure will be thorough and complete, and will fully convey the scope of the invention to those skilled in the art. In the drawings, the shapes and dimensions may be exaggerated for clarity, and the same reference numerals will be used throughout to designate the same or like components.

In an exemplary embodiment of the present invention, an anisotropic diffusion based on the direction of an edge is employed, and four types of directional pattern masks are applied to detect an edge from an image including noise. Here, the four types of directional pattern masks include a horizontal mask (HM), a vertical mask (VM), a diagonal mask from left_top toward right_bottom (DML), and a diagonal mask from right_top toward left_bottom (DMR).

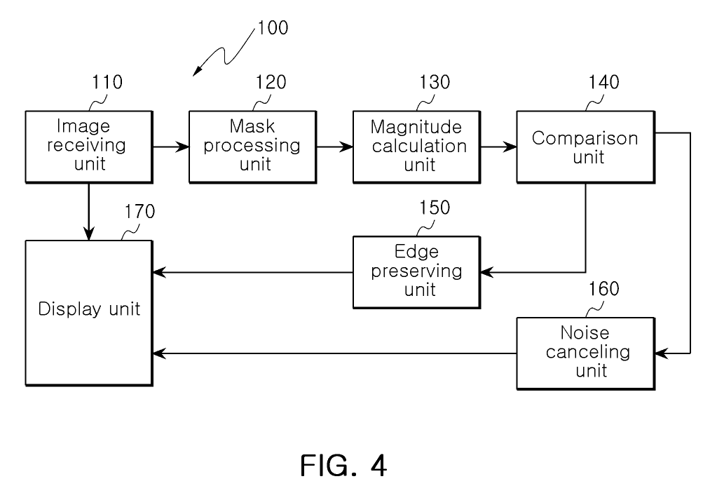

FIG. 4 is a schematic block diagram of an anisotropic diffusion apparatus for canceling noise while preserving an edge according to an exemplary embodiment of the present invention.

With reference to FIG. 4, the anisotropic diffusion apparatus 100 may include an image receiving unit 110, a mask processing unit 120, a magnitude calculation unit 130, a comparison unit 140, an edge preserving unit 150, a noise canceling unit 160, and a display unit 170.

The image receiving unit 110 receives an image captured by an image capturing device (not shown). The image received thusly includes noise.

The mask processing unit 120 discriminates the noise-contained image into pixels, and in order to detect an edge from the image, the mask processing unit 120 performs masking by applying the four types of directional pattern masks to adjacent pixels based on a current pixel.

The magnitude calculation unit 130 convolutes the directional pattern masks output from the mask processing unit 120 to calculate the magnitude corresponding to a line edge of the four types of directional pattern masks. This will be described in detail later.

The comparison unit 140 previously sets a threshold value proper for the characteristics of an image to discriminate a larger magnitude value and a smaller magnitude value, and compares the calculated magnitude value to the threshold value to check whether or not a current pixel corresponds to an edge region. Namely, if the magnitude value is larger than the threshold value, the comparison unit 140 determines that the current pixel corresponds to an edge region, outputs a corresponding result value to the edge preserving unit 150. If, however, the magnitude value is not larger than the threshold value, the comparison unit 140 determines that the current pixel does not correspond to an edge region and outputs a corresponding result value to the noise canceling unit 160.

The edge preserving unit 150 checks the value output from the comparison unit 140 and applies the edge stopping function in the corresponding direction to preserve the edge of the image. The edge preserving will be described in detail later.

The noise canceling unit 160 checks the value output from the comparison unit 140, applies anisotropic diffusion including diagonal pixel information by extending the cross-shaped kernel to strengthen noise cancellation in the current pixel of the image. In this case, eight-directional pixel information is used, so ⅛ is applied to λ.

The display unit 170 displays an image to which the anisotropic diffusion results, namely, the edge-preserved pixels which had been output from the edge preserving unit 150 or the noise-canceled pixels which had been output from the noise canceling unit 160, have been applied.

The direction-based anisotropic diffusion method for canceling noise while preserving an edge performed by the anisotropic diffusion apparatus will now be described in detail with reference to the accompanying drawings.

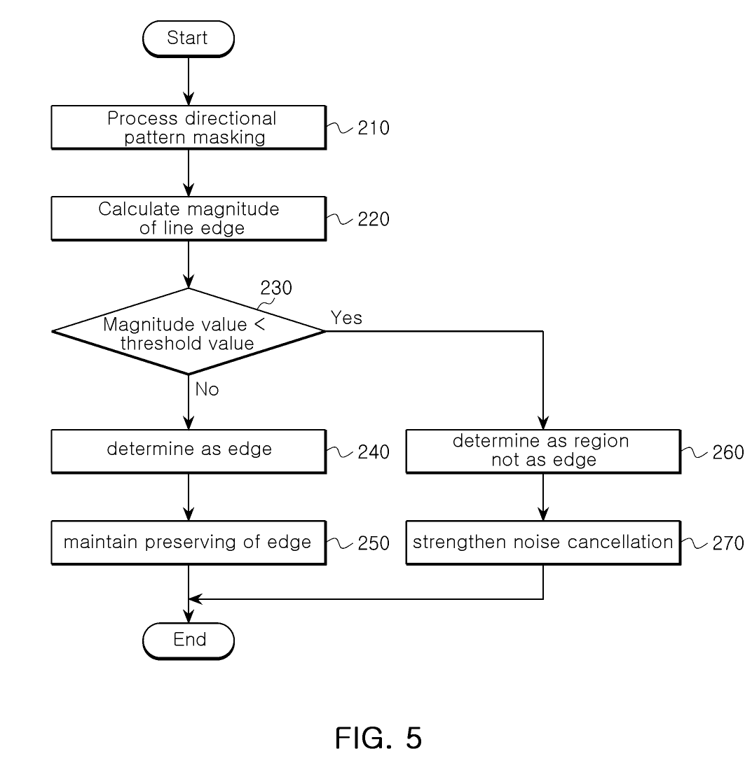

FIG. 5 is a flow chart illustrating the process of a direction-based anisotropic diffusion method according to an exemplary embodiment of the present invention.

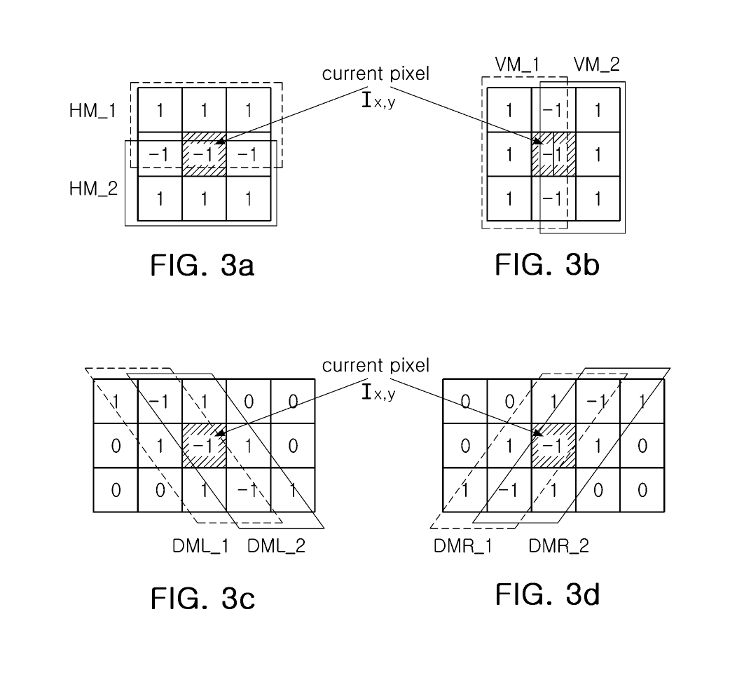

With reference to FIG. 5, in step 210, the anisotropic diffusion apparatus 100 performs directional pattern masking to determine the direction of an edge by applying the four types of directional pattern masks as shown in FIGS. 3a to 3d to current pixels of an image including noise. Namely, the anisotropic diffusion apparatus 100 calculates horizontal line values HM_{—}1 and HM_{—}2 by applying the horizontal mask (HM) as shown in FIG. 3a to detect a horizontal line edge, and calculates vertical line values VM_{—}1 and VM_{—}2 by applying the vertical mask (VM) as shown in FIG. 3b. Also, the anisotropic diffusion apparatus 100 calculates first diagonal line values DML_{—}1 and DML_{—}2 for the diagonal lines from left top toward right bottom by applying the diagonal mask that leans toward the right bottom from the left top as shown in FIG. 3c, and calculates second diagonal line values DMR_{—}1 and DMR_{—}2 for diagonal lines from right top toward left bottom by applying the diagonal mask that leans toward the left bottom from right top as shown in FIG. 3d.

In step 220, after processing the masks as shown in FIGS. 3a to 3d, the anisotropic diffusion apparatus 100 convolutes each calculated value to calculate the magnitude corresponding to line edges of the four types of directional pattern masks through arithmetic operation as represented by Equation 4 shown below:

MoH=\sqrt{Convolution(HM_{—}1)²+Convolution(HM_{—}2)²}

MoV=\sqrt{Convolution(VM_{—}1)²+Convolution(VM_{—}2)²}

MoD_{—}L=\sqrt{Convolution(DML_{—}1)²+Convolution(DML_{—}2)²}

MoD_{—}R=\sqrt{Convolution(DMR_{—}1)²+Convolution(DMR_{—}2)²} [Equation 4]

In Equation 4, MoH is a magnitude value of the horizontal line edge, MoV is a magnitude value of the vertical line edge, Mod_L is a magnitude value of the line edge in the diagonal direction from the left top toward the right bottom, and Mod_R is a magnitude value of the line edge in the diagonal direction from the right top toward the left bottom.

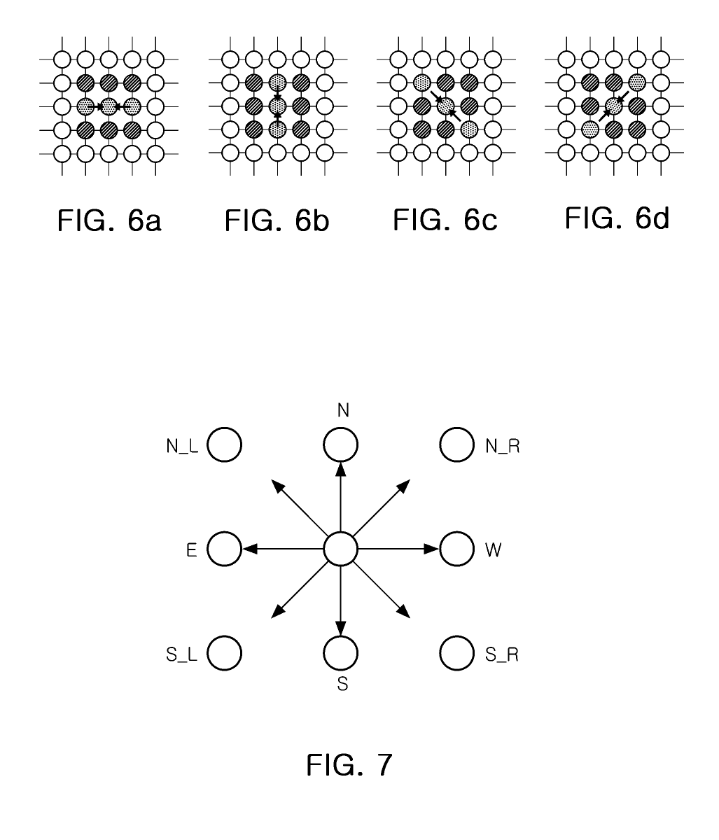

In step 230, the anisotropic diffusion apparatus 100 compares the respective magnitude values to the pre-set threshold value to check whether they are smaller than the threshold value. Upon checking, if the magnitude values are larger than the threshold value, the anisotropic diffusion apparatus 100 determines that the magnitude value is so high that the current pixel corresponds to an edge in step 240. Thereafter, in step 250, the anisotropic diffusion apparatus 100 maintains the preserving of the edge by applying an edge stopping function as represented by Equation 5 with a corresponding direction among the directions as shown in FIGS. 6a to 6d. Here, FIG. 6a illustrates the horizontal edge, FIG. 6b illustrates the vertical edge, FIG. 6c illustrates the diagonal edge leaning toward the right bottom from the left top, and FIG. 6d illustrates the diagonal edge leaning toward left bottom from right top.

if count of direction of edge=1

then λ=½

if count of direction of edge=2

then λ=¼

if count of direction of edge=3

then λ=⅙

if count of direction of edge=4

then λ=⅛ [Equation 5]

In Equation 5, λ is applied as represented by Equation 6 shown below depending on the number of applied edge directions.

I_{i,j}^{t+1}=I_{i,j}^{t}+λ[c_{D}·∇_{D}I]_{i,j}^{t} where D={directions of edge} [Equation 6]

Meanwhile, upon checking in step 230, if the magnitude value is not larger than the threshold value, the anisotropic diffusion apparatus 100 determines that the magnitude value is so low that the current pixel does not correspond to a region other than an edge region in step 260. Thereafter, in step 270, the anisotropic diffusion apparatus 100 extends the cross-shaped kernel to apply anisotropic diffusion including even the diagonal pixel information in the manner as proposed by Equation 7 shown below to strength noise cancellation. In this case, the eight-directional pixel information is in use, so ⅛ is applied to λ.

I_{i,j}^{t+1}=I_{i,j}^{t}+λ[c_{D}·∇_{D}I]_{i,j}^{t},

where D={East, West, South, North,

North_Left, North_Right, South_Left, South_Right} [Equation 7]

Through the direction-based anisotropic diffusion method performed by the anisotropic diffusion apparatus as described above, the direction of edges can be predicted. Thus, by increasing the rate of ‘K’ while using the exponent function of Equation 3 effective for edge preservation in the region corresponding to an edge, the edge preservation rate can be increased by setting a small value of ‘K”. Meanwhile, the inverse proportion function of Equation 2 effective for diffusion of a homogeneous region is applied to the region that does not correspond to an edge, to apply anisotropic diffusion based on the eight-directional kernel including the diagonal pixel information.

As set forth above, according to exemplary embodiments of the invention, an edge is detected by using four types of directional pattern masks and the edge stopping function in the anisotropic direction is applied to the direction of the detected edge, thereby effectively canceling (concealing) noise while preserving the edge representing the characteristics of an image, thus obtaining a high quality image.

While the present invention has been shown and described in connection with the exemplary embodiments, it will be apparent to those skilled in the art that modifications and variations can be made without departing from the spirit and scope of the invention as defined by the appended claims.

What is claimed is:

1. An anisotropic diffusion method based on the direction of an edge by an anisotropic diffusion apparatus, the method comprising:
performing direction pattern masking to determine the direction of an edge in an image including noise;
calculating the magnitude of an edge by applying line processing of values obtained through the direction pattern masking; and
canceling noise from the image while preserving the edge of the image according to the calculated magnitude value of the edge.

2. The method of claim 1, wherein the performing of the directional pattern masking to determine the edge direction comprises:
calculating horizontal line values to detect a horizontal line edge by applying a horizontal mask to a current pixel of the image;
calculating vertical line values to detect a vertical line edge by applying a vertical mask to the current pixel of the image;
calculating first diagonal line values to detect a diagonal line edge by applying a diagonal mask leaning toward right bottom from left top to the current pixel of the image; and
calculating second diagonal line values to detect a diagonal line edge by applying a diagonal mask leaning toward left bottom from right top to the current pixel of the image.

3. The method of claim 1, wherein, in calculating the magnitude of the edge, the respective values (HM_{—}1, HM_{—}2, VM_{—}1, VM_{—}2, DML_{—}1, DML_{—}2, DMR_{—}1, DMR_{—}2), which have been obtained through the respective directional pattern masking with respect to the horizontal (HM) mask, the vertical (VM) mask, the diagonal mask (DML) leaning toward left bottom from right top and the diagonal (DMR) mask leaning toward right bottom from left top, are convoluted to calculate the magnitudes (MoH, MoV, MoD_L, MoD_R) of respective edges as represented by Equation 4 shown below:
MoH=\sqrt{Convolution(HM_{—}1)²+Convolution(HM_{—}2)²}
MoV=\sqrt{Convolution(VM_{—}1)²+Convolution(VM_{—}2)²}
MoD_{—}L=\sqrt{Convolution(DML_{—}1)²+Convolution(DML_{—}2)²}
MoD_{—}R=\sqrt{Convolution(DMR_{—}1)²+Convolution(DMR_{—}2)²} [Equation 4]

4. The method of claim 1, wherein the canceling of noise from the image while preserving the edges of the image according to the calculated magnitude values of the edges comprises:
comparing the calculated magnitude values of the edges to a pre-set threshold value;
if the magnitude values are larger than the threshold value, determining that the current pixel of the image corresponds to an edge, and preserving the determined edge; and
if the magnitude values are smaller than the threshold value, determining that the current pixel of the image corresponds to a region, not an edge, and strengthening noise cancellation of the image.

5. The method of claim 4, wherein, in preserving the determined edge, the determined edge is preserved by applying an edge stopping function in a corresponding direction.

6. The method of claim 4, wherein in strengthening noise cancellation of the image, the noise cancellation of the image is strengthened by applying anisotropic diffusion including even pixel information in the diagonal direction by extending a cross-shaped kernel.

7. An anisotropic diffusion apparatus based on the direction of an edge, the apparatus comprising:
a masking unit configured to perform direction pattern masking to determine the direction of an edge in an image including noise;
a magnitude calculation unit configured to calculate the magnitude of the edge by applying line processing of values obtained through the direction pattern masking;
a comparison unit configured to compare the calculated magnitude value of the edge and a pre-set threshold value;
an edge preserving unit configured to determine that a current pixel of the image corresponds to an edge if the magnitude value is larger than the threshold value, and preserving the determined edge; and
a noise canceling unit configured to determine that a current pixel of the image corresponds to a region, not to an edge, if the magnitude value is not larger than the threshold value, and strengthening noise cancellation of the image.

8. The apparatus of claim 7, wherein the mask processing unit calculates horizontal line values to detect a horizontal line edge by applying a horizontal mask to a current pixel of the image, calculates vertical line values to detect a vertical line edge by applying a vertical mask to the current pixel of the image, calculates first diagonal line values to detect a diagonal line edge by applying a diagonal mask leaning toward right bottom from left top to the current pixel of the image, and calculates second diagonal line values to detect a diagonal line edge by applying a diagonal mask leaning toward left bottom from right top to the current pixel of the image.

9. The apparatus of claim 7, wherein the magnitude calculation unit convolutes the respective values (HM_{—}1, HM_{—}2, VM_{—}1, VM_{—}2, DML_{—}1, DML_{—}2, DMR_{—}1, DMR_{—}2), which have been obtained through the respective directional pattern masking with respect to the horizontal (HM) mask, the vertical (VM) mask, the diagonal mask (DML) leaning toward left bottom from right top and the diagonal (DMR) mask leaning toward right bottom from left top, to calculate the magnitudes (MoH, MoV, MoD_L, MoD_R) of respective edges as represented by Equation 4 shown below:
MoH=\sqrt{Convolution(HM_{—}1)²+Convolution(HM_{—}2)²}
MoV=\sqrt{Convolution(VM_{—}1)²+Convolution(VM_{—}2)²}
MoD_{—}L=\sqrt{Convolution(DML_{—}1)²+Convolution(DML_{—}2)²}
MoD_{—}R=\sqrt{Convolution(DMR_{—}1)²+Convolution(DMR_{—}2)²} [Equation 4]

10. The apparatus of claim 7, wherein the edge preserving unit preserves the determined edge by applying an edge stopping function in a corresponding direction.

11. The apparatus of claim 7, wherein the noise canceling unit strengthens the noise cancellation of the image by applying anisotropic diffusion including even pixel information in the diagonal direction by extending a cross-shaped kernel.
